(19) United States
(12) Patent Application Publication
(10) Pub. No.: US 2022/0135791 A1
(43) Pub. Date: May 5, 2022

(54) BIODEGRADABLE MATERIAL AND METHOD FOR PREPARING THE SAME

(71) Applicant: INDUSTRIAL TECHNOLOGY RESEARCH INSTITUTE, Hsinchu (TW)

(72) Inventors: Jin-An WU, Huwei Township (TW); Yun-Chen CHANG, Taichung City (TW); Sheng-Lung CHANG, Taoyuan City (TW); Shu-Chuan HUANG, Zhubei City (TW); Shin-Liang KUO, Hsinchu City (TW)

(73) Assignee: INDUSTRIAL TECHNOLOGY RESEARCH INSTITUTE, Hsinchu (TW)

(21) Appl. No.: 17/514,465

(22) Filed: Oct. 29, 2021

Related U.S. Application Data
(60) Provisional application No. 63/106,995, filed on Oct. 29, 2020.

(30) Foreign Application Priority Data
Sep. 9, 2021 (TW) 110133560

(51) Int. Cl. C08L 67/02; C08L 67/04; C08L 5/02; C08L 1/02

(52) U.S. Cl. CPC C08L 67/02; C08L 67/04; B65D 65/466; C08L 1/02; C08L 2201/06; C08L 5/02

(57) ABSTRACT

A biodegradable material and a method for preparing a biodegradable material are provided. The biodegradable material includes a continuous phase and a dispersed phase. The continuous phase includes a polyester, and the dispersed phase includes a modified saccharide oligomer. In particular, the weight ratio of the modified saccharide oligomer to the polyester is from 3:97 to 30:70. The dispersed phase has a maximum diameter of 100 nm to 900 nm.

### CROSS REFERENCE TO RELATED APPLICATIONS

This application claims benefit of U.S. Provisional Application No. 63/106,995, filed on Oct. 29, 2020, which is hereby incorporated herein by reference. The application is based on, and claims priority from, Taiwan Application Serial Number 110133560, filed on Sep. 9, 2021, the disclosure of which is hereby incorporated by reference herein in its entirety.

### TECHNICAL FIELD

The disclosure relates to a biodegradable material and a method for preparing the same.

### BACKGROUND

The rise of plastic packaging material is closely related to a general change in lifestyles. The use of light, convenient packaging for food storage and transportation, as well as increasing the shelf life of food, has become very important due to pressure from high population growth rates and food shortages. Although plastic packaging at present can satisfy demand, the consumption of plastic exceeds 160 million tons annually, of which 35% is used as packaging material. The treatment of waste from packaging material has a huge impact on the environment, so recycling plastic and studying degradable plastic have become more and more important.

Biodegradable material is a new type of polymer, which is characterized by the self-decomposition when its function is complete. The bonding between these polymers decomposes into environmentally friendly compositions through biological processes. Biodegradable materials exhibit better environmental compatibility than conventional materials. Currently, mainstream common biodegradable materials include polylactic acid (PLA), poly(butyleneadipate-co-terephthalate) (PBAT), or PLA-starch-blending (or PBAT-starch-blending) materials. Conventional biodegradable materials, however, would completely decompose under industrial composting conditions, and exhibit poor mechanical properties in comparison with common packaging materials (such as polyethylene (PE) or polypropylene (PP)), thereby limiting the application thereof. Polybutylene succinate (Polybutylene succinate, PBS) exhibits better biodegradability, great heat resistance and mechanical strength, thereby meeting the requirements of environmental protection (the raw material is a biomass source). Conventional polybutylene succinate, however, exhibits poor processability and has narrow application range due to its insufficient viscosity and melt strength resulting from the structure thereof.

### SUMMARY

The disclosure provides a biodegradable material. According to embodiments of the disclosure, the biodegradable material consists of a continuous phase and a dispersed phase, wherein the continuous phase includes a polyester, and the dispersed phase includes a modified saccharide oligomer, wherein the weight ratio of the modified saccharide oligomer to the polyester is from 3:97 to 30:70, wherein the dispersed phase has a maximum diameter of 100 nm to 900 nm.

According to embodiments of the disclosure, the disclosure also provides a method for preparing a biodegradable material of the disclosure. According to embodiments of the disclosure, the method includes dissolving a modified saccharide oligomer in water to obtain an aqueous solution, wherein the solid content of the aqueous solution is from 5 wt % to 30 wt %; introducing a material into an extruder and performing a melt blending process, wherein the material comprises a polyester; introducing the aqueous solution into the extruder via a high-pressure perfusion process after completely melting the material; removing moisture from the extruder to obtain a melt after performing a high-pressure aqueous dispersion process via an extruder; and cooling and drying the melt to obtain the biodegradable material.

A detailed description is given in the following embodiments.

### BRIEF DESCRIPTION OF THE DRAWINGS

FIG. 1 is a cross-sectional view of the biodegradable material according to an embodiment of the disclosure.

FIG. 2 is a scanning electron microscope (SEM) photography of the biodegradable material disclosed in Example 3.

FIG. 3 is scanning electron microscope (SEM) photography of the biodegradable material disclosed in Comparative Example 2.

### DETAILED DESCRIPTION

The biodegradable polyester of the disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. As used herein, the term “about” in quantitative terms refers to plus or minus an amount that is general and reasonable to persons skilled in the art.

The disclosure provides a biodegradable material and a method for preparing the same. The method for preparing the biodegradable material of the disclosure includes a melt blending process in combination with a high-pressure aqueous dispersion process, thereby forcing the modified saccharide oligomer (on a nanometer scale) (i.e. the particle size of the modified saccharide oligomer is less than or equal to about 900 nm) to uniformly disperse within the polyester. As a result, the biodegradability of the biodegradable material of the disclosure can be enhanced, resulting in that the biodegradable material of the disclosure can be decomposed in an environment at room temperature (i.e. decomposed in the absence of an industrial composting system). In addition, since the intermolecular hydrogen bond can be formed between the modified saccharide oligomer and the polyester, thereby forming high branched structure and increasing molecular chain entanglement). Due to the steric hindrance produced from the modified saccharide oligomer, the nucleation point of the saccharide oligomer is increased, thereby enhancing the melt strength and thermal tolerance of the biodegradable polyester. The biodegradable material, for example, can have a melt strength from 40 mN to 80 mN and a melt flow index from 0.5 g/10 min to 10 g/10 min). As a result, the processability of the biodegradable material for subsequent process can be improved. According to embodiments of the disclosure, the biodegradable polymer material of the disclosure can be used to produce biodegradable films, such as agricultural films, packaging materials, or shopping bags, via a blown film process or a film extrusion process.

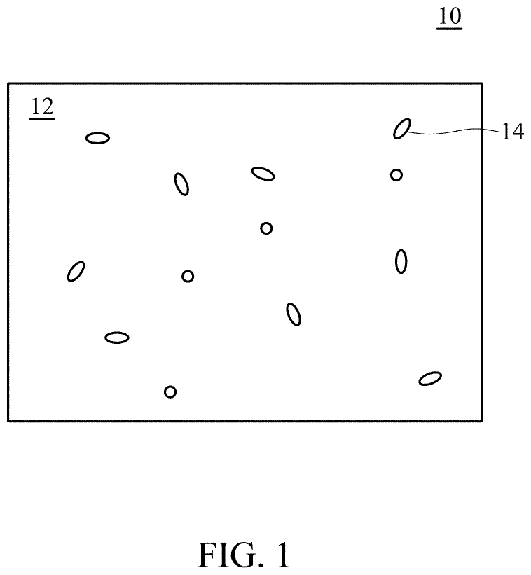

According to embodiments of the disclosure, the disclosure provides a biodegradable material. FIG. 1 is a cross-sectional view of the biodegradable material according to an embodiment of the disclosure. As shown in FIG. 1, the biodegradable material 10 can consist of a continuous phase 12 and a dispersed phase 14. The continuous phase 12 can include a polyester, and the dispersed phase 14 can include a modified saccharide oligomer. According to embodiments of the disclosure, the weight ratio of the modified saccharide oligomer to the polyester can be from about 3:97 to 30:70, such as about 5:95, 7:93, 10:90, 15:85, 20:80, or 25:75. The biodegradability, melt strength, and mechanical properties (such as tensile strength and elongation) of the biodegradable material of the disclosure can be adjusted dependent on the weight ratio of the modified saccharide oligomer to the polyester. When the modified saccharide oligomer is too low, the biodegradable polyester exhibits poor biodegradability is not apt to be decomposed in an environment at room temperature. The biodegradability and mechanical properties of the biodegradable material can be accordingly enhanced along with the increase in the amount of modified saccharide oligomer. However, when there is too much modified saccharide oligomer, the humidity resistance of the biodegradable polyester may be reduced.

Since the biodegradable material of the disclosure is prepared by the melt blending process in combination with the high-pressure aqueous dispersion process, the dispersed phase (such as the modified saccharide oligomer) can be uniformly dispersed on a nanometer scale in the continuous phase. Herein, the term “uniformly dispersed on a nanometer scale” means that the maximum diameter of each dispersed phase in the cross-section of the biodegradable material is less than or equal to about 900 nm (such as between 100 nm and 900 nm, between 100 nm and 800 nm, between 100 nm and 600 nm, between 200 nm and 900 nm, between 200 nm and 800 nm, between 200 nm and 600 nm, between 300 nm and 900 nm, between 300 nm and 800 nm, or between 300 nm and 600 nm).

According to embodiments of the disclosure, the dispersed phase substantially consists of the modified saccharide oligomer (i.e. other components may be antioxidant). Therefore, in the biodegradable material of the disclosure, the modified saccharide oligomer is uniformly dispersed on a nanometer scale in the polyester. Namely, in the biodegradable material of the disclosure, the maximum diameter of the modified saccharide oligomer is less than or equal to about 900 nm (such as between 100 nm and 900 nm, between 100 nm and 800 nm, between 100 nm and 600 nm, between 200 nm and 900 nm, between 200 nm and 800 nm, between 200 nm and 600 nm, between 300 nm and 900 nm, between 300 nm and 800 nm, or between 300 nm and 600 nm).

According to embodiments of the disclosure, the polyester can have at least one repeating unit represented by Formula (I)

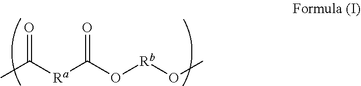

wherein R^{a} and R^{b} are independently C₁₋₈ alkylene group, or phenylene group. According to embodiments can be linear or branched alkylene group. For example, C₁₋₈ alkylene group can be methylene group, ethylene group, propylene group, butylene group, pentylene group, hexylene group, heptylene group, octylene group or an isomer thereof.

According to embodiments of the disclosure, the polyester can have at least one repeating unit represented by Formula (II)

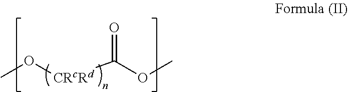

wherein R^{c} are independently hydrogen, or C₁₋₃ alkyl group; R^{d} are independently hydrogen, or C₁₋₃ alkyl group; and, n is 1, 2, or 3. According to embodiments of the disclosure, C₁₋₃ alkyl group can be linear or branched alkyl group. For example, C₁₋₃ alkyl group can be methyl, ethyl, propyl, or an isomer thereof.

According to embodiments of the disclosure, the polyester can be polybutylene succinate (PBS), polybutylene adipate (PBA), polybutylene succinate-co-adipate (PBSA), polyethylene succinate (PES), polybutylene terephthalate (PBT), polybutylene adipate-co-terephthalate (PBAT), polylactide (PLA), polyhydroxyalkanoate (PHA), or a combination thereof. According to embodiments of the disclosure, the polyhydroxyalkanoate can be poly(3-hydroxybutyrate), (P3HB), poly (3-hydroxyvalerate) (PHV), poly (3-hydroxyhexanoate), (PHH), poly (3-hydroxybutyrate-co-3-hydroxyvalerate (PHBV), or poly (3-hydroxybutyrate-3-hydroxycaproate) (PHBH).

According to embodiments of the disclosure, the weight average molecular weight (Mw) of the polyester can be from about 500 g/mol to 100,000 g/mol, such as about 800 g/mol to 90,000 g/mol, 1,000 g/mol to 80,000 g/mol, 2,000 g/mol to 80,000 g/mol, 3,000 g/mol to 80,000 g/mol, 4,000 g/mol to 80,000 g/mol, or 5,000 g/mol to 70,000 g/mol. The weight average molecular weight (Mw) of the polyester of the disclosure can be determined by gel permeation chromatography (GPC) based on a polystyrene calibration curve. According to embodiments of the disclosure, when the molecular weight of the polyester is too high or too low, the processability of the biodegradable material may be reduced, resulting in a too low or too high decomposition efficiency.

According to embodiments of the disclosure, the modified saccharide oligomer of the disclosure can be a product formed by reacting a saccharide oligomer with a modifier via a reaction (such as esterification or condensation). Namely, the modified saccharide oligomer of the disclosure can be a saccharide oligomer which is modified with a modifier. One purpose for modifying the saccharide oligomer is to increase the hydrophilicity of the saccharide oligomer, thereby forcing the modified saccharide oligomer uniformly dispersing in water. In addition, another purpose for modifying the saccharide oligomer is to obtain a modified saccharide oligomer having a functional group (such as hydroxyl group) which can form an intermolecular hydrogen bond with the polyester (such as the ester group of the polyester), thereby enhancing the chain entanglement and improving the melt strength and thermal tolerance of the biodegradable polyester.

According to embodiments of the disclosure, the saccharide oligomer can be cellulose oligomer (such as hydroxypropyl methylcellulose), dextrin, cyclodextrin (such as: α-cyclodextrin, β-cyclodextrin, γ-cyclodextrin, or δ-cyclodextrin), or a combination thereof.

According to embodiments of the disclosure, the saccharide oligomer can be a saccharide oligomer having at least one repeating unit represented by Formula (III), a saccharide oligomer having at least one repeating unit represented by Formula (IV), or a combination thereof.

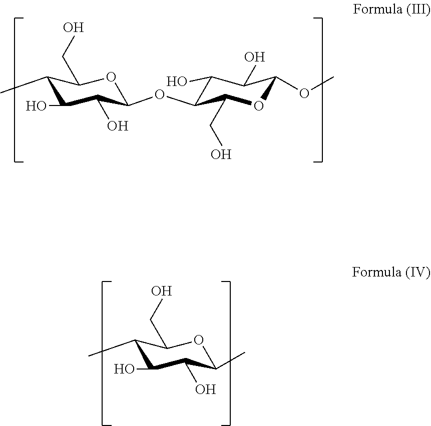

According to embodiments of the disclosure, the saccharide oligomer can be a saccharide oligomer having at least one repeating unit represented by Formula (III), wherein all or parts of hydroxyl groups of the repeating unit represented by Formula (III) can be replaced with C₁₋₆ alkoxy group, or C₂₋₆ alkoxyalkyl. According to some embodiments of the disclosure, the saccharide oligomer can be a saccharide oligomer having at least one repeating unit represented by Formula (IV), wherein all or parts of hydroxyl groups of the repeating unit represented by Formula (IV) can be replaced with C₁₋₆ alkoxy group, or C₂₋₆ alkoxyalkyl. According to embodiments of the disclosure, C₁₋₆ alkoxy group can be linear or branched alkoxy 1 group. For example, C₁₋₆ alkoxy group can be methoxy, ethoxy, propoxy, butoxy, pentoxy, hexoxy, or an isomer thereof. For example C₂₋₆ alkoxyalkyl can be —CH₂—O—CH₃, —CH—O—C₂H₅, —CH—O—C₃H₇, —CH₂—O—C₄H₉, —CH₂—O—C₅H₁₁, —C₂H₄O—CH₃, —C₂H₄—O—C₂H₅, —C₂H₄—O—C₃H₇, —C₂H₄—O—C₄H₉, —C₃H₆—O—CH₃, —C₃H₆—O—C₂H₅, —C₃H₆—O—C₃H₇, —C₄H₈—O—CH₃, —C₄H₈—O—C₂H₅, or —C₅H₁₀—O—CH₃.

According to embodiments of the disclosure, the modifier can be anhydride, a compound having one or two reactive functional groups, or a combination thereof, wherein the reactive functional group is carboxyl group, hydroxyl group, or glycidyl group. According to embodiments of the disclosure, the number of the reactive functional group of the modifier can be 1 or 2. Namely, the number of the reactive functional group of the modifier is less than 3. According to embodiments of the disclosure, the modifier is not a monomer with multiple functional groups or a chain extender.

According to embodiments of the disclosure, the modifier can be anhydride, carboxylic acid, or a combination thereof. When the modifier is carboxylic acid, the carboxylic acid can be linear or branched C₂₋₈ polybasic carboxylic acid, such as oxalic acid, malonic acid, succinic acid, pentanedioic acid, adipic acid, pimelic acid, suberic acid, itaconic acid, 2-hydroxy succinic acid, maleic acid, citric acid. In addition, the carboxylic acid can be aryl-group-containing carboxylic acid, such as benzoic acid. When the modifier is carboxylic acid anhydride, the carboxylic acid anhydride can be linear, cyclic or branched C₂₋₁₈ carboxylic acid anhydride, such as acetic anhydride, succinic anhydride, maleic anhydride, n-dodecyl succinic anhydride, n-tetradecylsuccinic anhydride, methacrylic anhydride, phthalic anhydride, or benzoic anhydride.

According to embodiments of the disclosure, the modifier can be oxalic acid, malonic acid, succinic acid, pentanedioic acid, adipic acid, maleic acid, citric acid, acetic anhydride, succinic anhydride, maleic anhydride, methacrylic anhydride, n-dodecyl succinic anhydride, n-tetradecylsuccinic anhydride, benzoic anhydride, glycidol, or a combination thereof.

According to embodiments of the disclosure, the weight average molecular weight of the modified saccharide oligomer can be 800 g/mol to 5,000 g/mol (such as about 800 to 4,800, 1,000 to 4,500, or 1,000 to 4,300). When the weight average molecular weight of the modified saccharide oligomer is too low, the modified saccharide oligomer exhibits poor melt strength and thermal tolerance. When the weight average molecular weight of the modified saccharide oligomer is too high, the modified saccharide oligomer is not apt to be uniformly dispersed on a nanometer scale in the polyester, resulting in poor melt strength and thermal tolerance, and reduced biodegradability. The weight average molecular weight (Mw) of the modified saccharide oligomer of the disclosure can be determined by gel permeation chromatography (GPC) based on a polystyrene calibration curve).

According to embodiments of the disclosure, the average degree of substitution of the modified saccharide oligomer can be from about 0.5 to 5, such as about 0.6, 0.8, 1.0, 1.2, 1.5, 2.0, 2.5, 3.0, 3.5, 4.0, 4.5, or 5.0. The average degree of substitution of the disclosure means that the average number of hydroxyl groups, which are replaced with a modified group, after modifying the saccharide oligomer.

Herein, the average degree of substitution of the modified saccharide oligomer can be determined via a titration. When the average degree of substitution of the modified saccharide oligomer is too low, the modified saccharide oligomer exhibits a low hydrophilicity, thereby reducing the number of intermolecular hydrogen bonds between the modified saccharide oligomer and the polyester. As a result, the obtained biodegradable material exhibits poor melt strength, poor thermal tolerance, and reduced biodegradability.

According to embodiments of the disclosure, the modified saccharide oligomer can include a saccharide oligomer having at least one repeating unit represented by Formula (V), a saccharide oligomer having at least one repeating unit represented by Formula (VI), or a combination thereof

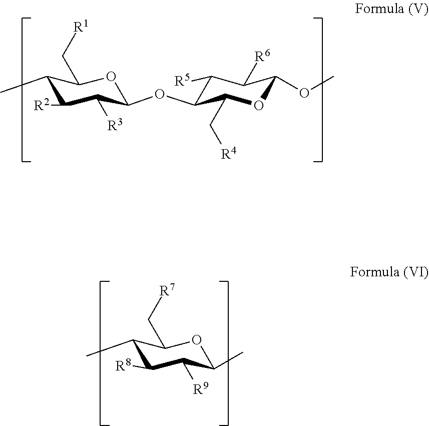

In particular, R1, R2, R3, R4, R5, R6, R7, R8, and R9 are independently —OH, C₁₋₆ alkoxy group, or C₂₋₆ alkoxyalkyl,

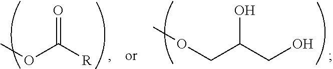

at least one of R¹, R², R³, R⁴, R⁵, and R⁶ is

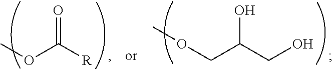

at least one of R⁷, R⁸, and R⁹ is

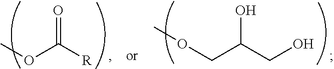

and, R is hydrogen, C₁₋₈ alkyl group, aryl group, or C₂₋₁₈ carboxyl group.

According to embodiments of the disclosure, the biodegradable material further includes an antioxidant, wherein the amount of antioxidant is from 0.05 wt % to 1.5 wt %, based on the total weight of the polyester and the modified saccharide oligomer. According to embodiments of the disclosure, the antioxidant can be phenol-based compound, phosphorus-based compound, sulfur-based compound, or a combination thereof.

According to embodiments of the disclosure, the phenol-based compound can be 2,6-di-tert-butyl-p-cresol, 2,6-diphenyl-4-octadesiloxyphenol, stearyl(3,5-di-tert-butyl-4-hydroxyphenyl)propionate, 3,5-di-tert-butyl-4-hydroxybenzyl)phosphonate, tridecyl.3,5-di-tert-butyl-4-hydroxybenzyl thioacetate, thiodiethylenebis[(3,5-di-tert-butyl-4-hydroxyphenyl)propionate], 4,4′-thiobis(6-tert-butyl-m-cresol), 2-octylthio-4,6-di(3,5-di-tert-butyl-4-hydroxyphenoxy)-s-triazine, 2,2′-methylenebis(4-methyl-6-tert-butylphenol, bis[3,3-bis(4-hydroxy-3-tert-butylphenyl)butyric acid]glycolester, 4,4′-butylidenebis(2,6-di-tert-butylphenol), 2,2′-ethylidenebis(4,6-di-tert-butylphenol), 1,1,3-tris(2-methyl-4-hydroxy-5-tert-butylphenyl)butane, bis[2-tert-butyl-4-methyl-6-(2-hydroxy-3-tert-butyl-5-methylbenzyl)phenyl]terephthalate, 1,3,5-tris(2,6-dimethyl-3-hydroxy-4-tert-butylbenzyl) isocyanurate, 1,3,5-tris(3,5-di-tert-butyl-4-hydroxybenzyl)isocyanurate, 1,3,5-tris(3,5-di-tert-butyl-4-hydroxybenzyl)-2,4,6-trimethylbenzene, 1,3,5-tris[(3,5-di-tert-butyl-4-hydroxyphenyl)propionyloxyethyl]isocyanurate, tetrakis[methylene-3-(3′,5′-di-tert-butyl-4′-hydroxyphenyl)propionate]methane, 2-tert-butyl-4-methyl-6-(2-acryloyloxy-3-tert-butyl-5-methylbenzyl)phenol, 3,9-bis[2-(3-tert-butyl-4-hydroxy-5-methylhydrocirnnamoyloxy)-1,1-dimethylethyl]-2,4,8,10-tetraoxaspiro[5,5]undecane, triethyleheglycolbis[β-(3-tert-butyl-4-hydroxy-5-methylphenyl)propionate], or a combination thereof.

According to embodiments of the disclosure, the phosphorus-based compound can be triphenyl phosphite, tris(2,4-di-tert-butylphenyl) phosphite, tris(2,5-di-tert-butylphenyl)phosphite, tris(nonylphenyl)phosphite, tris(dinonylphenyl)phosphite, tris(mono,di-mixed nonylphenyl)phosphite, diphenylacid phosphite, 2,2′-methylenebis(4,6-di-tert-butylphenyl)octyl phosphite, diphenyldecyl phosphite, diphenyloctyl phosphite, di(nonylphenyl)pentaerythritol diphosphite, phenyldiisodecyl phosphite, tributyl phosphite, tris(2-ethylhexyl)phosphite, tridecyl phosphite, trilauryl phosphite, dibutyl acid phosphite, dilauryl acid phosphite, trilauryl trithiophosphite, bis(neopentylglycol).1,4-cyclohexanedimethyl diphosphite, bis(2,4-di-tert-butylphenyl)pentaerythritol diphosphite, bis(2,5-di-tert-butylphenyl)pentaerythritol diphosphite, bis(2,6-di-tert-butyl-4-methylphenyl)pentaerythritol diphosphite, bis(2,4-dicumylphenyl)pentaerythritol diphosphite, distearylpentaerythritol diphosphite, bis[2,2′-methylenebis(4,6-diamylphenyl)].isopropylidenediphenyl phosphite, tetratridecyl.4,4′-butylidenebis(2-tert-butyl-5-methylphenol)diphosphite, hexa(tridecyl).1,1,3-tris(2-methyl-5-tert-butyl-4-hydroxyphenyl)butane. triphosphite, tetrakis(2,4-di-tert-butylphenyl)biphenylene diphosphonite, tris(2-[(2,4,7,9-tetrakis-tert-butyldibenzo[d,f][1,3,2]dioxaphosphepin-6-yl)oxy]ethyl)amine, 9,10-dihydro-9-oxa-10-phosphaphenanthrene-10-oxide, tris(2-[(2,4,8,10-tetrakis-tert-butyldibenzo[d,f][1,3,2]dioxaphosphepin-6-yl)oxy]ethyl)amine, (2-(1,1-dimethylethyl)-6-methyl-4-[3-[[2,4,8,10-tetrakis(1,1-dimethylethyl)dibenzo[d,f][1,3,2]dioxaphosphepin-6-yl]oxy]propyl]phenol2-butyl-2-ethylpropanediol, 2,4,6-tri-tert-butylphenol monophosphate, or a combination thereof. According to embodiments of the disclosure, the sulfur-based compound can be dialkyl thiodipropionates, β-alkylmercaptopropionic acid esters, or a combination thereof. According to embodiments of the disclosure, the biodegradable material of the disclosure can include 3-30 parts by weight of the modified saccharide oligomer, and 70-97 parts by weight of the polyester. The total weight of the modified saccharide oligomer and the polyester is 100 parts by weight. According to embodiments of the disclosure, the particle size of the modified saccharide oligomer is less than or equal to about 900 nm (such as between 100 nm and 900 nm, between 100 nm and 800 nm, between 100 nm and 600 nm, between 200 nm and 900 nm, between 200 nm and 800 nm, between 200 nm and 600 nm, between 300 nm and 900 nm, between 300 nm and 800 nm, or between 300 nm and 600 nm). According to embodiments of the disclosure, the biodegradable material can further include an antioxidant, wherein the amount of antioxidant is from 0.05 wt % to 1.5 wt %, based on the total weight of the polyester and the modified saccharide oligomer.

According to embodiments of the disclosure, the biodegradable material of the disclosure can be a product preparing by following steps. First, a modified saccharide oligomer is dissolved in water to obtain an aqueous solution, wherein the solid content of the aqueous solution is from 5 wt % to 30 wt %. Next, a material is introduced into an extruder to undergo a melt blending process, wherein the material includes polyester. Next, after completely melting the material, the aqueous solution is introduced into the extruder via a high-pressure perfusion process. Next, a high-pressure aqueous dispersion process is performed by the extruder, and then a melt is obtained after removing moisture from the extruder. Next, the melt is cooled and dried, obtaining the biodegradable material. According to embodiments of the disclosure, the weight ratio of the modified saccharide oligomer to the polyester is from 3:97 to 30:70 (such as: about 5:95, 7:93, 10:90, 15:85, 20:80, or 25:75). According to embodiments of the disclosure, the material further includes an antioxidant, wherein the amount of antioxidant is from about 0.05 wt % to 1.5 wt % (such as 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, or 1.4 wt %), based on the total weight of the polyester and the modified saccharide oligomer. According to embodiments of the disclosure, the process temperature of the melt blending process can be from about 130° C. to 180° C. (such as: about 140° C., 150° C., 160° C., 170° C.). According to embodiments of the disclosure, the pressure of the high-pressure perfusion process can be from about 100 psi to 300 psi (such as: about 120 psi, 140 psi, 160 psi, 180 psi, 200 psi, 220 psi, 240 psi, 260 psi, or 280 psi).

According to embodiments of the disclosure, the method for preparing the modified saccharide oligomer of the disclosure can include following steps. First, a saccharide oligomer, a modifier, and a catalyst are mixed at 20° C.-100° C. for 0.5-8 hours, wherein the molar ratio of the modifier to the saccharide oligomer can be 1:2 to 6:1, such as 1:1, 2:1, 3:1, 4:1 or 5:1. According to embodiments of the disclosure, the saccharide oligomer, modifier, and catalyst can be dispersed in a solvent. The amount of catalyst may be 0.1 wt % to 30 wt %, based on the weight of the saccharide oligomer. According to embodiments of the disclosure, the average degree of substitution of the obtained modified saccharide oligomer is directly proportional to the molar ratio of the modifier to the saccharide oligomer. According to embodiments of the disclosure, the catalyst can be conventional esterification catalyst, such as organic zinc, organic titanium, organic tin, sulfuric acid, potassium hydroxide, potassium carbonate, 4-dimethylaminopyridine (DMAP), or a combination thereof. Next, the product was precipitated and cleaned with acetone. After filtering and drying, the modified saccharide oligomer is obtained.

According to embodiments of the disclosure, the method for preparing the biodegradable polyester of the disclosure can include following steps. First, a modified saccharide oligomer is dissolved in water to obtain an aqueous solution, wherein the solid content of the aqueous solution about 5 wt % to 30 wt % (such as about 10 wt %, 15 wt %, 20 wt %, or 25 wt %) (based on the total weight of the modified saccharide oligomer and water). Next, a material is introduced into an extruder to undergo a melt blending process, wherein the material includes a polyester. Next, after completely melting the material, the aqueous solution is introduced into the extruder via a high-pressure perfusion process. For example, the aqueous solution including the modified saccharide oligomer is introduced into the screw of the extruder). Next, a high-pressure aqueous dispersion process is performed by the extruder to uniformly disperse the modified saccharide oligomer on a nanometer scale in the polyester melt. After removing moisture from the extruder, a melt is obtained. Next, the melt is cooled and dried, obtaining the biodegradable material.

In related art of biodegradable material, in order to enhance the melt strength, the viscosity, molecular chain entanglement and melt strength of the biodegradable material, a polyol (with a number of hydroxyl groups larger than or equal to 3), a polybasic acid (with a number of carboxyl group larger than or equal to 3) and/or a reactive chain extender (or a monomer) (with a number of reactive functional group larger than or equal to 3) may be further introduced into the extruder to undergo a copolymerization or a chain extension reaction of polymer with terminal function group to obtain a high branched structure via a blending process. However, the aforementioned method employing the chain extender is easy to cause the rapid rise of molecular weight, resulting in excessive crosslinking or excessive degree of branching. As a result, a gelatinization of the obtained polyester occurs, thereby reducing the processability, mechanical properties and biodegradability of the polyester.

The method of the disclosure employs an extruder to subject the polyester to a melt blending process. After completely melting the polyester, the aqueous solution including the modified saccharide oligomer is introduced into the screw of the extruder by a high-pressure perfusion process to undergo an nanoscale aqueous dispersion process.

Due to the hydrophilicity, the modified saccharide oligomer can be uniformly dispersed in the aqueous solution. As a result, the modified saccharide oligomer can also be uniformly dispersed on a nanometer scale in the polyester and there are intermolecular hydrogen bonds formed between the modified saccharide oligomer and the polyester, obtaining a high branched structure with increased molecular chain entanglement.

Therefore, on the premise that the mechanical properties is not deteriorated, the melt strength and thermal tolerance of the biodegradable polyester can be enhanced to a suitable range. The biodegradable material, for example, can have a melt strength from 40 mN to 80 mN, and a melt flow index from 0.5 g/10 min to 10 g/10 min. Therefore, the processability of the biodegradable material for subsequent process can be improved. In addition, due to the introduction of the modified saccharide oligomer, the biodegradability of the polyester material can be adjusted by the amount of modified saccharide oligomer. According to embodiments of the disclosure, the method for preparing the biodegradable material of the disclosure is performed in the absence of a trihydric alcohol, a ternary acid, and/or a reactive chain extender (or a monomer) with a number of reactive functional group larger than or equal to 3. Namely, the biodegradable material of the disclosure does not employ trihydric alcohol, ternary acid, or reactive chain extender (or monomer) as raw material.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLE

Modified Saccharide Oligomer

### Preparation Example 1

β-cyclodextrin (commercially available from Emperor Chemical Co., Ltd.) was dissolved in 1-methyl-2-pyrrolidinone at 30-80° C., obtaining a first solution (with a solid content of 20 wt %). Next, succinic anhydride and 4-dimethylaminopyridine (DMAP) were dissolved in 1-methyl-2-pyrrolidinone at 20-50° C., obtaining a second solution, wherein the molar ratio of succinic anhydride to cyclodextrin was 5:1, the amount of 4-dimethylaminopyridine (DMAP) was 3 wt % (based on the weight of β-cyclodextrin), and the solid content of the second solution was 1 wt %. Next, the second solution was added into the first solution, and the mixture was stirred at 80-100° C. for 2-6 hours. Next, the obtained result was precipitated and washed with acetone. Finally, after filtering and drying, Modified saccharide oligomer (1) (with an average degree of substitution of about 2.4).

### Preparation Example 2

Maltodextrin (commercially available from San Fu Chemical Co Ltd) was dissolved in 1-methyl-2-pyrrolidinone at 30-80° C., obtaining a first solution (with a solid content of 20 wt %). Next, succinic acid and tetrabutyl titanate were dissolved in 1-methyl-2-pyrrolidinone at 20-50° C., obtaining a second solution, wherein the molar ratio of succinic acid to maltodextrin was 5:1, the amount of tetrabutyl titanate was 5 wt % (based on the weight of maltodextrin), and the solid content of the second solution was 1.7 wt %. Next, the second solution was added into the first solution, and the mixture was stirred at 80-100° C. for 2-6 hours. Next, the obtained result was precipitated and washed with acetone. Finally, after filtering and drying, Modified saccharide oligomer (2) (with an average degree of substitution of about 2.2) was obtained.

### Preparation Example 3

Hydroxypropylmethyl cellulose (commercially available from Emperor Chemical Co., Ltd.) was dissolved in 1-methyl-2-pyrrolidinone at 30-80° C., obtaining a first solution (with a solid content of 20 wt %). Next, succinic anhydride and 4-dimethylaminopyridine (DMAP) were dissolved in 1-methyl-2-pyrrolidinone at 20-50° C., obtaining a second solution, wherein the molar ratio of succinic anhydride to hydroxypropylmethyl cellulose was 5:1, the amount of 4-dimethylaminopyridine (DMAP) was 1 wt % (based on the weight of hydroxypropylmethyl cellulose), and the solid content of the second solution was 0.33 wt %. Next, the second solution was added into the first solution, and the mixture was stirred at 80-100° C. for 2-6 hours. Next, the obtained result was precipitated and washed with acetone. Finally, after filtering and drying, Modified saccharide oligomer (3) (with an average degree of substitution of about 3.1) was obtained.

Biodegradable Material

### Example 1

10 parts by weight of Modified saccharide oligomer (1) was dissolved in water, and the result was mixed by a homogenizer, obtaining an aqueous solution including Modified saccharide oligomer (1), wherein the aqueous solution including Modified saccharide oligomer (1) had a solid content of 20 wt %, 90 parts by weight of polybutylene succinate (PBS) (with a trade number of FZ91PM, commercially available from Mitsubishi Chemical Taiwan Co., Ltd.) (with a molecular weight of about 48,500 g/mol), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after the mixture was melted completely, the aqueous solution including Modified saccharide oligomer (1) was introduced into the twin-screw extruder via a high-pressure perfusor and the pressure was maintained at 113 psi. Next, Modified saccharide oligomer (1) was subjected to a high-pressure aqueous dispersion process via the screw, thereby uniformly dispersing the modified saccharide oligomer on a nanometer scale in the polyester melt. Next, the water vapor was discharged by vacuuming at the terminal of the twin-screw extruder, obtaining a melt. Next, after cooling the melt, the result was subjected to a pelletization via a pelletizer. Next, the obtained masterbatch was dried at 70° C., obtaining biodegradable material (1).

The melt flow index, melt strength, tensile strength, elongation, and heat distortion temperature of Biodegradable material (1) were measured, and the results are shown in Table 1. The melt flow index was determined by the method of ASTM D 1238(190° C./2.16 kg). The melt strength was determined by capillary rheometer in concert with melt strength test at a temperature of 135° C. and a wheel traction acceleration of 24 mm/s. The tensile strength was determined by the method of ASTM D3574. The elongation was determined by the method of ASTM D412 using a universal tensile machine. The heat distortion temperature was determined by the method of ASTM D412 (with a sample thickness of ⅛ inch, at a pressure of 66 psi).

### Example 2

Example 2 was performed in the same manner as in Example 1, except that the amount of Modified saccharide oligomer (1) was increased from 10 parts by weight to 20 parts by weight, and the amount of polybutylene succinate (PBS) was reduced from 20 parts by weight to 10 parts by weight, obtaining Biodegradable material (2).

The melt flow index, melt strength, tensile strength, elongation, and heat distortion temperature of Biodegradable material (2) were measured, and the results are shown in Table 1.

### Comparative Example 1

100 parts by weight of polybutylene succinate (PBS) (with a trade number of FZ91PM, commercially available from Mitsubishi Chemical Taiwan Co., Ltd.) (with a molecular weight of about 48,500 g/mol), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after cooling the obtained melt, the result was subjected to a pelletization via a pelletizer. Next, the obtained masterbatch was dried at 70° C. obtaining Biodegradable material (3).

The melt flow index, melt strength, tensile strength, elongation, and heat distortion temperature of Biodegradable material (3) were measured, and the results are shown in Table 1.

TABLE 1

| | | | Comparative |
|---|---|---|---|
| | Example 1 | Example 2 | Example 1 |
| PBS(parts by weight) | 90 | 80 | 100 |
| modified saccharide | 10 | 20 | 0 |
| oligomer (1) | | | |
| tensile strength | 335 | 372 | 315 |
| (kg/cm²) | | | |
| elongation (%) | 258 | 267 | 221 |
| melt flow index | 2.8 | 1.9 | 5.8 |
| (2.16 kg@190° C.) | | | |
| melt strength (mN) | 58.9 | 60.2 | 35.8 |
| heat distortion | 96.0 | 95.9 | 95.2 |
| temperature (° C.) | | | |

As shown in Table 1, in comparison with the biodegradable material of the disclosure (i.e. Example 1 and Example 2), the polyester prepared by subjecting the polyester (PBS) and the antioxidant to a melt blending process in the absence of the modified saccharide oligomer of the disclosure (i.e. biodegradable material (3) of Comparative Example 1) exhibits a relatively low melt strength (less than 40 mN), and poor tensile strength and elongation.

### Example 3

Example 3 was performed in the same manner as in Example 1, except that Modified saccharide oligomer (1) was replaced with Modified saccharide oligomer (2), obtaining Biodegradable material (4).

The melt flow index, melt strength, tensile strength, elongation, and heat distortion temperature of Biodegradable material (4) were measured, and the results are shown in Table 2.

### Example 4

Example 4 was performed in the same manner as in Example 2, except that Modified saccharide oligomer (1) was replaced with Modified saccharide oligomer (2), obtaining Biodegradable material (5).

The melt flow index, melt strength, tensile strength, elongation, and heat distortion temperature of Biodegradable material (5) were measured, and the results are shown in Table 2.

### Comparative Example 2

90 parts by weight of polybutylene succinate (PBS) (with a trade number of FZ91PM, commercially available from Mitsubishi Chemical Taiwan Co., Ltd.) (with a molecular weight of about 48,500 g/mol), 10 parts by weight of saccharide oligomer (2), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after cooling the obtained melt, the result was subjected to a pelletization via a pelletizer. Next, the obtained masterbatch was dried at 70° C., obtaining biodegradable material (6).

The melt flow index, melt strength, tensile strength, elongation, and heat distortion temperature of Biodegradable material (6) were measured, and the results are shown in Table 2.

TABLE 2

| | | | Comparative |
|---|---|---|---|
| | Example 3 | Example 4 | Example 2 |
| PBS(parts by weight) | 90 | 80 | 90 |
| modified saccharide | 10 | 20 | 10 |
| oligomer (2) | | | |
| Method of preparation | dissolving the | dissolving the | directly mixing |
| | modified saccharide | modified saccharide | the modified |
| | oligomer into water | oligomer into water | saccharide |
| | to form an aqueous | to form an aqueous | oligomer with |
| | solution, introducing | solution. introducing | polyester to |
| | the aqueous solution | the aqueous solution | perform a melt |
| | into the molten | into the molten | blending process |
| | polyester, and | polyester, and | |
| | performing a high- | performing a high- | |
| | pressure aqueous | pressure aqueous | |
| | dispersion process | dispersion process | |
| tensile strength (kg/cm²) | 366 | 349 | 285 |
| elongation (%) | 250 | 261 | 186 |
| melt flow index (2.16 | 1.8 | 1.6 | 6.9 |
| kg@190° C.) | | | |
| melt strength (mN) | 65.5 | 66.9 | 28.9 |
| heat distortion | 96.2 | 96.4 | 91.0 |
| temperature (° C.) | | | |

As shown in Table 2, in comparison with the biodegradable material of the disclosure (i.e. Example 3), the polyester prepared by subjecting the modified saccharide oligomer and the polyester to a melt blending process (i.e. Biodegradable material (6) of Comparative Example 2) exhibits relatively low melt strength (less than 40 mN), and poor tensile strength and elongation. The polyester (i.e. Biodegradable material (4)) of Example 3 (prepared by dissolving the modified saccharide oligomer into water to form an aqueous solution, introducing the aqueous solution into the molten polyester, and performing a high-pressure aqueous dispersion process) has the same components as the polyester of Comparative Example 2 but prepared from different method. As a result, the tensile strength of Biodegradable material (4) is about 1.28 times greater than that of Biodegradable material (6), the elongation of Biodegradable material (4) is about 1.34 times greater than that of Biodegradable material (6), and the melt strength of Biodegradable material (4) is about 2.27 times greater than that of Biodegradable material (6).

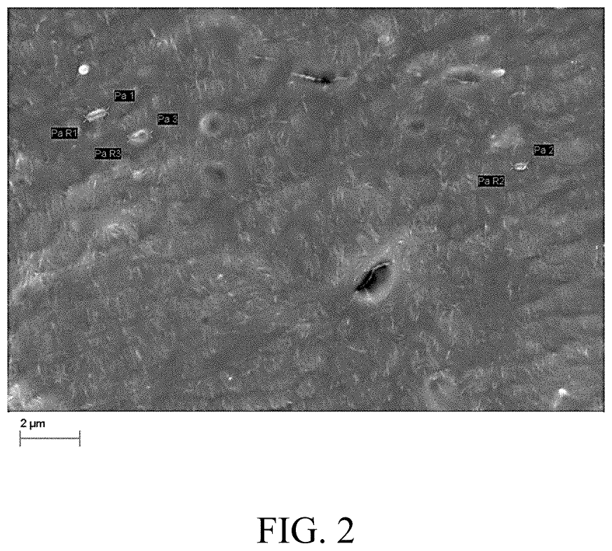

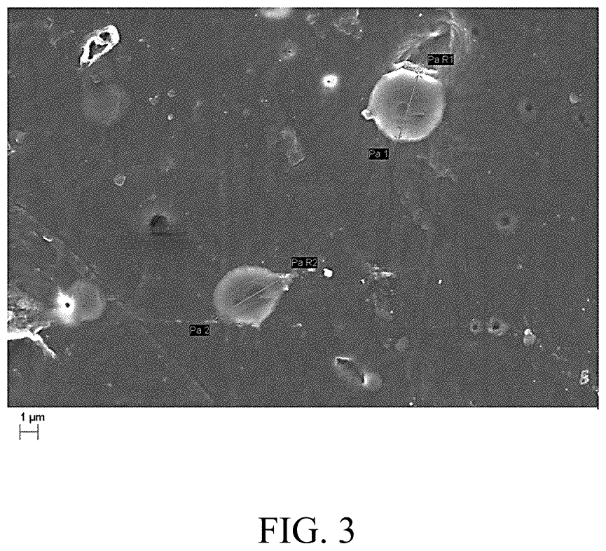

Next, the cross-section of Biodegradable material (4) of Example 3 was observed using a scanning electron microscope (SEM) and the result is shown in FIG. 2; and, the cross-section of Biodegradable material (6) of Example 3 was observed using a scanning electron microscope (SEM) and the result is shown in FIG. 3. As shown in FIG. 2, in Biodegradable material (4) prepared by the method of the disclosure (employing high-pressure aqueous dispersion process), the size of the modified saccharide oligomer can be less than 900 nm (such as between 300 nm and 700 nm). Accordingly, in the biodegradable material of the disclosure the modified saccharide oligomer is uniformly dispersed on a nanometer scale in the polyester material. In addition, FIG. 3 clearly shows that the size of each modified saccharide oligomers is greater than 1 μm (such as 3.83 μm or 4.18 μm). Accordingly, in the polyester material prepared by merely subjecting the modified saccharide oligomer and the polyester to a melt blending process, the modified saccharide oligomer cannot be uniformly dispersed on a nanometer scale in the polyester material.

The biodegradability of Biodegradable material (4) (Example 3) and Biodegradable material (6) (Comparative Example 2) was evaluated, and the results clearly show that there is an obvious weight loss in Biodegradable material (4). It means that Biodegradable material (4) exhibits better biodegradability.

### Example 5

10 parts by weight of modified saccharide oligomer (3) was dissolved in water, and the result was mixed by a homogenizer, obtaining an aqueous solution including Modified saccharide oligomer (3), wherein the aqueous solution including Modified saccharide oligomer (3) had a solid content of 20 wt %, 90 parts by weight of polybutylene succinate-co-adipate (PBSA) (with a trade number of FD92PM, commercially available from SHANG SHIEN CHENG INDUSTRY CO., LTD.) (with a molecular weight of about 52,300 g/mol), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after the mixture was melted completely, the aqueous solution including Modified saccharide oligomer (3) was introduced into the twin-screw extruder via a high-pressure perfusor and the pressure was maintained at 113 psi. Next, Modified saccharide oligomer (1) was subjected to a high-pressure aqueous dispersion process via the screw, thereby uniformly dispersing the modified saccharide oligomer on a nanometer scale in the polyester melt. Next, the water vapor was discharged by vacuuming at the terminal of the twin-screw extruder, obtaining a melt. Next, after cooling the melt, the result was subjected to a pelletization via a pelletizer. Next, the obtained masterbatch was dried at 70° C., obtaining Biodegradable material (7).

The melt flow index, melt strength, tensile strength, elongation, and heat distortion temperature of Biodegradable material (7) were measured, and the results are shown in Table 3.

### Example 6

Example 6 was performed in the same manner as in Example 3, except that polybutylene succinate (PBS) was replaced with polybutylene adipate-co-terephthalate (PBAT) (with a trade number of Ecovio® F23B1, commercially available from BASF TAIWAN LTD.) (with a molecular weight of about 45,900 g/mol), obtaining Biodegradable material (8).

The melt flow index, melt strength, tensile strength, elongation, and heat distortion temperature of Biodegradable material (8) were measured, and the results are shown in Table 3.

### Comparative Example 3

Comparative Example 3 was performed in the same manner as in Comparative Example 1, except that polybutylene succinate (PBS) was replaced with polybutylene succinate-co-adipate (PBSA) (with a trade number of FD92PM, commercially available from SHANG SHIEN CHENG INDUSTRY CO., LTD.) (with a molecular weight of about 52,300 g/mol), obtaining Biodegradable material (9).

The melt flow index, melt strength, tensile strength, elongation, and heat distortion temperature of Biodegradable material (9) were measured, and the results are shown in Table 3.

### Comparative Example 4

Comparative Example 4 was performed in the same manner as in Comparative Example 1, except that polybutylene succinate (PBS) was replaced with polybutylene adipate-co-terephthalate (PBAT) (with a trade number of Ecovio® F23B1, commercially available from BASF TAIWAN LTD.) (with a molecular weight of about 45,900 g/mol), obtaining Biodegradable material (10).

The melt flow index, melt strength, tensile strength, elongation, and heat distortion temperature of Biodegradable material (10) were measured, and the results are shown in Table 3.

### Comparative Example 5

Comparative Example 5 was performed in the same manner as in Comparative Example 1, except that polybutylene succinate (PBS) was replaced with polylactide (PLA) (with a trade number of LX175, commercially available from SHANG SHIEN CHENG INDUSTRY CO., LTD.) (with a molecular weight of about 65,200 g/mol), obtaining Biodegradable material (11).

The melt flow index, melt strength, tensile strength, elongation, and heat distortion temperature of Biodegradable material (11) were measured, and the results are shown in Table 3.

TABLE 3

| | | | Comparative | Comparative | Comparative |
|---|---|---|---|---|---|
| | Example 5 | Example 6 | Example 3 | Example 4 | Example 5 |
| PBSA(parts by weight) | 90 | 0 | 100 | 0 | 0 |
| PBAT(parts by weight) | 0 | 90 | 0 | 100 | 0 |
| PLA(parts by weight) | 0 | 0 | 0 | 0 | 100 |
| modified saccharide | 0 | 10 | 0 | 0 | 0 |
| oligomer (2) | | | | | |
| modified saccharide | 10 | 0 | 0 | 0 | 0 |
| oligomer (3) | | | | | |
| tensile strength (kg/cm²) | 2.67 | 256 | 265 | 252 | 530 |
| elongation (%) | 607 | 758 | 608 | 789 | 25 |
| melt flow index | 2.9 | 3.9 | 3.8 | 3.5 | 8.9 |
| (2.16 kg@190° C.) | | | | | |
| melt strength (mN) | 55.3 | 61.4 | 31.9 | 36.1 | 18.0 |
| heat distortion | 65.3 | 50.1 | 62.1 | 47.4 | 59.5 |
| temperature (° C.) | | | | | |

As shown in Table 3, in comparison with the biodegradable material of the disclosure (i.e. Example 1 and Example 2), the polyester prepared by subjecting the polyester and antioxidant to a melt blending process in the absence of the modified saccharide oligomer of the disclosure exhibits relatively low melt strength (less than 40 mN).

### Example 7

10 parts by weight of modified saccharide oligomer (2) was dissolved in water, and the result was mixed by a homogenizer, obtaining an aqueous solution including Modified saccharide oligomer (2), wherein the aqueous solution including Modified saccharide oligomer (2) had a solid content of 20 wt %, 70 parts by weight of polybutylene succinate (PBS) (with a trade number of FZ91PM, commercially available from Mitsubishi Chemical Taiwan Co., Ltd.) (with a molecular weight of about 48,500 g/mol), 20 parts by weight of polybutylene adipate-co-terephthalate (PBAT) (with a trade number of Ecovio® F23B1, commercially available from BASF TAIWAN LTD.) (with a molecular weight of about 45,900 g/mol), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after the mixture was melted completely, the aqueous solution including Modified saccharide oligomer (2) was introduced into the twin-screw extruder via a high-pressure perfusor and the pressure was maintained at 113 psi. Next, Modified saccharide oligomer (2) was subjected to a high-pressure aqueous dispersion process via the screw, thereby uniformly dispersing the modified saccharide oligomer on a nanometer scale in the polyester melt. Next, the water vapor was discharged by vacuuming at the terminal of the twin-screw extruder, obtaining a melt. Next, after cooling the melt, the result was subjected to a pelletization via a pelletizer. Next, the obtained masterbatch was dried at 70° C., obtaining Biodegradable material (12).

The melt flow index, melt strength, tensile strength, elongation, and heat distortion temperature of Biodegradable material (12) were measured, and the results are shown in Table 4.

### Comparative Example 6

70 parts by weight of polybutylene succinate (PBS) (with a trade number of FZ91PM, commercially available from Mitsubishi Chemical Taiwan Co., Ltd.) (with a molecular weight of about 48,500 g/mol), 20 parts by weight of polybutylene adipate-co-terephthalate (PBAT) (with a trade number of Ecovio® F23B1, commercially available from BASF TAIWAN LTD.) (with a molecular weight of about 45,900 g/mol), 10 parts by weight of saccharide oligomer (2), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after cooling the obtained melt, the result was subjected to a pelletization via a pelletizer. Next, the obtained masterbatch was dried at 70° C., obtaining Biodegradable material (13).

The melt flow index, melt strength, tensile strength, elongation, and heat distortion temperature of Biodegradable material (13) were measured, and the results are shown in Table 4.

### Example 8

20 parts by weight of modified saccharide oligomer (2) was dissolved in water, and the result was mixed by a homogenizer, obtaining an aqueous solution including Modified saccharide oligomer (2), wherein the aqueous solution including Modified saccharide oligomer (2) had a solid content of 20 wt %, 70 parts by weight of polybutylene succinate (PBS) (with a trade number of FZ91PM, commercially available from Mitsubishi Chemical Taiwan Co., Ltd.), 10 parts by weight of polylactide (PLA) (with a trade number of LX175, commercially available from SHANG SHIEN CHENG INDUSTRY CO., LTD.) (with a molecular weight of about 65,200 g/mol), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after the mixture was melted completely, the aqueous solution including Modified saccharide oligomer (2) was introduced into the twin-screw extruder via a high-pressure perfusor and the pressure was maintained at 113 psi. Next, Modified saccharide oligomer (2) was subjected to a high-pressure aqueous dispersion process via the screw, thereby uniformly dispersing the modified saccharide oligomer on a nanometer scale in the polyester melt. Next, the water vapor was discharged by vacuuming at the terminal of the twin-screw extruder, obtaining a melt. Next, after cooling the melt, the result was subjected to a pelletization via a pelletizer. Next, the obtained masterbatch was dried at 70° C., obtaining Biodegradable material (14).

The melt flow index, melt strength, tensile strength, elongation, and heat distortion temperature of Biodegradable material (14) were measured, and the results are shown in Table 4.

### Example 9

10 parts by weight of Modified saccharide oligomer (1) and 10 parts by weight of Modified saccharide oligomer (2) was dissolved in water, and the result was mixed by a homogenizer, obtaining an aqueous solution including the modified saccharide oligomer, wherein the aqueous solution including the modified saccharide oligomer had a solid content of 20 wt %, 10 parts by weight of polybutylene succinate (PBS) (with a trade number of FZ91PM, commercially available from Mitsubishi Chemical Taiwan Co., Ltd.) (with a molecular weight of about 48,500 g/mol), 70 parts by weight of parts by weight of polybutylene adipate-co-terephthalate (PBAT) (with a trade number of Ecovio® F23B1, commercially available from BASF TAIWAN LTD.) (with a molecular weight of about 45,900 g/mol), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after the mixture was melted completely, the aqueous solution including the modified saccharide oligomer was introduced into the twin-screw extruder via a high-pressure perfusor and the pressure was maintained at 113 psi. Next, the modified saccharide oligomer was subjected to a high-pressure aqueous dispersion process via the screw, thereby uniformly dispersing the modified saccharide oligomer on a nanometer scale in the polyester melt. Next, the water vapor was discharged by vacuuming at the terminal of the twin-screw extruder, obtaining a melt. Next, after cooling the melt, the result was subjected to a pelletization via a pelletizer. Next, the obtained masterbatch was dried at 70° C., obtaining Biodegradable material (15).

The melt flow index, melt strength, tensile strength, elongation, and heat distortion temperature of Biodegradable material (15) were measured, and the results are shown in Table 4.

### Example 10

5 parts by weight of modified saccharide oligomer (2) and 15 parts by weight of modified saccharide oligomer (3) was dissolved in water, and the result was mixed by a homogenizer, obtaining an aqueous solution including the modified saccharide oligomer, wherein the aqueous solution including the modified saccharide oligomer had a solid content of 20 wt %, 70 parts by weight of parts by weight of polybutylene adipate-co-terephthalate (PBAT) (with a trade number of Ecovio® F23B1, commercially available from BASF TAIWAN LTD.) (with a molecular weight of about 45,900 g/mol), 10 parts by weight of polylactide (PLA) (with a trade number of LX175, commercially available from SHANG SHIEN CHENG INDUSTRY CO., LTD.) (with a molecular weight of about 65,200 g/mol), 0.1 parts by weight of AO-1010 (serving as antioxidant, commercially available from Taiwan Jhonsin Co Ltd.), and 0.1 parts by weight of AO-168 (serving as antioxidant, commercially available from Taiwan Jhonsin Co Ltd.) were uniformly mixed, obtaining a mixture. Next, the mixture was introduced into a twin-screw extruder, and a melt blending process was performed at 150° C. Next, after the mixture was melted completely, the aqueous solution including the modified saccharide oligomer was introduced into the twin-screw extruder via a high-pressure perfusor and the pressure was maintained at 113 psi. Next, the modified saccharide oligomer was subjected to a high-pressure aqueous dispersion process via the screw, thereby uniformly dispersing the modified saccharide oligomer on a nanometer scale in the polyester melt. Next, the water vapor was discharged by vacuuming at the terminal of the twin-screw extruder, obtaining a melt. Next, after cooling the melt, the result was subjected to a pelletization via a pelletizer. Next, the obtained masterbatch was dried at 70° C. obtaining Biodegradable material (16).

The melt flow index, melt strength, tensile strength, elongation, and heat distortion temperature of Biodegradable material (16) were measured, and the results are shown in Table 4.

TABLE 4

| | | Comparative | | | |
|---|---|---|---|---|---|
| | Example 7 | Example 6 | Example 8 | Example 9 | Example 1 0 |
| PBS(parts by weight) | 70 | 70 | 70 | 10 | 0 |
| PBAT(parts by weight) | 20 | 20 | 0 | 70 | 70 |
| PLA(parts by weight) | 0 | 0 | 10 | 0 | 10 |
| modified saccharide | 0 | 0 | 0 | 10 | 0 |
| oligomer (1) | | | | | |
| modified saccharide | 10 | 10 | 20 | 10 | 5 |
| oligomer (2) | | | | | |
| modified saccharide | 0 | 0 | 0 | 0 | 15 |
| oligomer (3) | | | | | |
| Method of preparation | dissolving the | directly mixing | dissolving the | dissolving the | dissolving the |
| | modified saccharide | the modified | modified saccharide | modified saccharide | modified saccharide |
| | oligomer into water | saccharide | oligomer into water | oligomer into water | oligomer into water |
| | to form an aqueous | oligomer with | to form an aqueous | to form an aqueous | to form an aqueous |
| | solution, introducing | polyester to | solution, introducing | solution, introducing | solution, introducing |
| | the aqueous solution | perform a melt | the aqueous solution | the aqueous solution | the aqueous solution |
| | into the molten | blending process | into the molten | into the molten | into the molten |
| | polyester, and | | polyester, and | polyester, and | polyester, and |
| | performing a high- | | performing a high- | performing a high- | performing a high- |
| | pressure aqueous | | pressure aqueous | pressure aqueous | pressure aqueous |
| | dispersion process | | dispersion process | dispersion process | dispersion process |
| tensile strength | 287 | 237 | 398 | 269 | 275 |
| (kg/cm²) | | | | | |
| elongation (%) | 365 | 268 | 213 | 584 | 653 |
| melt flow index | 2.7 | 6.7 | 3.2 | 3.0 | 5.9 |
| (2.16 kg@190 ° C.) | | | | | |
| melt strength (mN) | 70.6 | 30.4 | 58.2 | 69.8 | 61.5 |
| heat distortion | 78.9 | 78.4 | 89.6 | 58.5 | 51.8 |
| temperature (° C.) | | | | | |

As shown in Table 4, in comparison with the biodegradable material of Example 7, the polyester (i.e. Biodegradable material (13) of Comparative Example 6) prepared by subjecting the modified saccharide oligomer and polyester to a melt blending process exhibits relatively low melt strength (less than 40 mN) and poor tensile strength and elongation. The polyester (i.e. Biodegradable material (12)) of Example 7 (prepared by dissolving the modified saccharide oligomer into water to form an aqueous solution, introducing the aqueous solution into the molten polyester, and performing a high-pressure aqueous dispersion process) has the same components as the polyester of Comparative Example 6 but prepared from different method. As a result, the tensile strength of Biodegradable material (12) is about 1.21 times greater than that of Biodegradable material (13), the elongation of Biodegradable material (12) is about 1.36 times greater than that of Biodegradable material (13), and the melt strength of Biodegradable material (12) is about 2.32 times greater than that of Biodegradable material (13).

It will be clear that various modifications and variations can be made to the disclosed methods and materials. It is intended that the specification and examples be considered as exemplary only, with the true scope of the disclosure being indicated by the following claims and their equivalents.

What is claimed is:

1. A biodegradable material, consisting of a continuous phase and a dispersed phase, wherein the continuous phase comprises a polyester, and the dispersed phase comprises a modified saccharide oligomer, wherein the weight ratio of the modified saccharide oligomer to the polyester is from 3:97 to 30:70, wherein the dispersed phase has a maximum diameter less than or equal to 900 nm.

2. The biodegradable material as claimed in claim 1, wherein the polyester has at least one repeating unit represented by Formula (I) 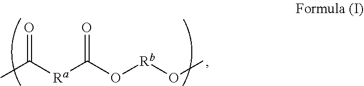
wherein R^{a} and R^{b} are independently C₁₋₈ alkylene group, or phenylene group.

3. The biodegradable material as claimed in claim 1, wherein the polyester has at least one repeating unit represented by Formula (II) 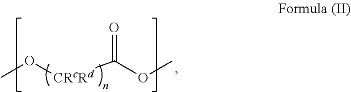
wherein R^{c} and R^{d} are independently hydrogen, or C₁₋₃ alkyl group; and, n is 1, 2, or 3.

4. The biodegradable material as claimed in claim 1, wherein the weight average molecular weight of the polyester is from 500 to 100,000 g/mol.

5. The biodegradable material as claimed in claim 1, wherein the polyester is polybutylene succinate (PBS), polybutylene adipate (PBA), polybutylene succinate-co-adipate (PBSA), polyethylene succinate (PES), polybutylene terephthalate (PBT), polybutylene adipate-co-terephthalate (PBAT), polylactide (PLA), polyhydroxyalkanoate (PHA), or a combination thereof.

6. The biodegradable material as claimed in claim 1, wherein the modified saccharide oligomer is a product of a saccharide oligomer reacted with a modifier, wherein the modifier is an anhydride, a compound having one or two reactive functional groups, or a combination thereof, wherein the reactive functional group is carboxyl group, hydroxyl group, or glycidyl group.

7. The biodegradable material as claimed in claim 6, wherein the modifier is formic acid, acetic acid, propionic acid, butyric acid, valeric acid, caproic acid, heptanoic acid, caprylic acid, benzoic acid, acetic anhydride, succinic anhydride, maleic anhydride, methacrylic anhydride, n-dodecyl succinic anhydride, n-tetradecylsuccinic anhydride, benzoic anhydride, glycidol, or a combination thereof.

8. The biodegradable material as claimed in claim 6, wherein the saccharide oligomer is cellulose oligomer, dextrin, cyclodextrin, or a combination thereof.

9. The biodegradable material as claimed in claim 1, wherein the weight average molecular weight of the modified saccharide oligomer is from 800 g/mol to 5,000 g/mol.

10. The biodegradable material as claimed in claim 1, wherein the average degree of substitution of the modified saccharide oligomer is from 0.5 to 5.

11. The biodegradable material as claimed in claim 1, wherein the modified saccharide oligomer comprises a saccharide oligomer having at least one repeating unit represented by Formula (III), a saccharide oligomer having at least one repeating unit represented by Formula (IV), or a combination thereof 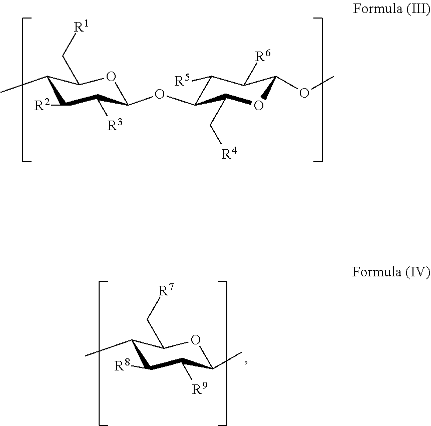
wherein R¹, R², R³, R⁴, R⁵, R⁶, R⁷, R⁸, and R⁹ are independently —OH, C₁₋₆ alkoxy group, or C₂₋₆ alkoxyalkyl, 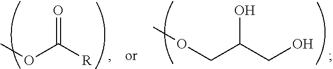
at least one of R¹, R², R³, R⁴, R⁵, and R⁶ is 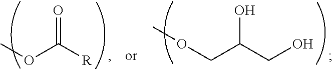
at least one of R⁷, R⁸, and R⁹ is 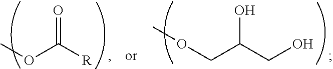
R is hydrogen, C₁₋₈ alkyl group, aryl group, or C₂₋₁₈ carboxyl group.

12. A method for preparing a biodegradable material, comprising:
dissolving a modified saccharide oligomer into water to form an aqueous solution, wherein the solid content of the aqueous solution is from 5 wt % to 30 wt %;
introducing a material into an extruder and performing a melt blending process, wherein the material comprises a polyester;
introducing the aqueous solution into the extruder via a high-pressure perfusion process after completely melting the material;
removing moisture from the extruder to obtain a melt after performing a high-pressure aqueous dispersion process via an extruder; and
cooling and drying the melt to obtain the biodegradable material.

13. The method for preparing a biodegradable material as claimed in claim 12, wherein the pressure of the high-pressure perfusion process is from 100 psi to 300 psi.

14. The method for preparing a biodegradable material as claimed in claim 12, wherein the weight ratio of the modified saccharide oligomer to the polyester is from 3:97 to 30:70.
